(19) United States
(12) Patent Application Publication
(10) Pub. No.: US 2008/0231241 A1
(43) Pub. Date: Sep. 25, 2008

(54) Transformers

(76) Inventor: Eric Anthony Lewis, Warwickshire (GB)

Correspondence Address: KIRSCHSTEIN, OTTINGER, ISRAEL;& SCHIFFMILLER, P.C., 425 FIFTH AVENUE, 5TH FLOOR, NEW YORK, NY, 10016-2223, US

(21) Appl. No.: 11/661,303

(22) PCT Filed: Aug. 25, 2005
(86) PCT No.: PCT/GB2005/003322

§ 371 Date: Jun. 25, 2007

(30) Foreign Application Priority Data
Aug. 26, 2004 (GB) 0418992.4

(51) Int. Cl. H02J 3/00; H01F 19/00; H01F 27/28

(52) U.S. Cl. 323/215; 323/355; 336/223

(57) ABSTRACT

A multi-transformer unit is operative for converting an input AC voltage at a first voltage level to a net output AC voltage at a second voltage level. The multi-transformer unit can be used in place of a conventional transformer or an AC machine and is designed to suppress the transfer of harmonics between the input and output AC voltages. The unit comprises at least two phase-shifting transformers, each transformer being operative to provide a phase shift relative to the first voltage level. On the primary side of the unit the transformers are arranged for independent connection to the first voltage level, whereas on the secondary side of the unit the transformers are linked such that voltage vectors on the secondary side of the unit are added together to at least partially cancel the harmonic pollution and give the net output AC voltage. Moreover, the phase shift of the phase-shifting transformers may be selected to completely or substantially add into the net AC output voltage of the multi-transformer unit the fundamental voltage/frequency applied to its input AC voltage.

### FIELD OF THE INVENTION

The present invention relates to The present invention relates to transformers, and in particular to anti-harmonic transformers that are suitable for use with both conventional land-based AC systems and dedicated AC systems.

### BACKGROUND OF THE INVENTION

FIG. 1 shows a small part of a conventional land-based AC power system. A number of AC power generators 2 generate power at an AC higher voltage level such as 11 kV (3-phase), for example. The power is supplied directly to a series of high power loads 4 such as high power thyristor converters feeding motors used in steel mills. A series of low power loads 6 such as computers and televisions operate at an AC lower voltage level (415V for 3-phase or 240V for 1-phase, for example). The power generated by the AC power generators 2 must therefore be converted before it can be supplied to the low power loads 6. This conversion is carried out by a pair of AC transformers 8 such as a standard distribution transformer supplied by Brush Transformers Ltd of Loughborough, Leicestershire, LE11 1HN, United Kingdom. The generators, transformers and loads are connected to the higher and lower voltage levels through circuit breakers, indicated by the symbol “X”.

It is often the case that the high power loads 4 produce distorting effects in the AC higher power level. A typical distorting effect is the production of AC harmonic voltages (referred to throughout this patent specification as “harmonics”). These can be exact or non-exact integers of the fundamental frequency of the power generated by the AC power generators 2. For example, if the fundamental frequency of the power generated by the AC power generators is 50 Hz then the frequency of the fifth harmonic will be 50×5=250 Hz.

The AC transformers 8 that convert the power from the AC higher voltage level to the AC lower voltage level will also pass any harmonics that are present in the AC higher voltage level to the AC lower voltage level. This means that the distorting effects produced by the high power loads 4 are effectively transferred from the AC higher voltage level to the AC lower voltage level by the AC transformers 8. Any harmonics transferred to the AC lower voltage level from the AC higher voltage level will have the same frequency as the original harmonics in the AC higher voltage level, but with a small reduction in the relative percentage amplitudes due to the impedance of the various circuits.

For such conventional systems, the harmonics present at the AC higher voltage level are normally controlled by the design of the system to meet defined standards that provide an acceptable level of harmonics at the AC higher voltage level and at the AC lower voltage level.

FIG. 2 shows a dedicated AC power system similar to those that can be used in areas that are away from centres of population such as in desert regions, in large industrial facilities or on ships using electrical propulsion. The dedicated AC power system has two well-defined sets of loads both at the AC higher voltage level and at two AC lower voltage levels. Because all the loads are known, a dedicated AC power system is often designed to tolerate a higher level of harmonics at the AC higher voltage level because this can provide a more economic system overall.

As in the AC power system shown in FIG. 1, an AC transformer 8 is used to convert the power from the AC higher voltage level to the first AC lower voltage level. The AC transformer 8 will therefore pass any harmonics that are present in the AC higher voltage level to the first AC lower voltage level. As a consequence of this, the high power loads 4 on the AC higher voltage level and the low power loads 10 on the first AC lower voltage level must be designed to withstand an increased level of harmonics. However, there are many low power loads that are simply not economical when operated with an increased level of AC harmonics. In the dedicated AC power system of FIG. 2, these low power loads 12 are connected to a second AC lower voltage level and are supplied with power by means of a pair of AC machines 14. The AC machines 14 transmit the power supplied by the AC power generators 2 using their rotary shafts 15 but do not pass any harmonics from the AC higher voltage level to the second AC lower voltage level. The second AC lower voltage level is therefore free from the harmonics applied to the AC higher voltage level but it is not always possible or cost effective to provide a completely separate AC lower voltage level and a pair of AC power machines 14. A suitable AC power machine would be the power converting AC synchronous motor plus AC generator set supplied by Alstom Electrical Machines Ltd of Rugby, CV21 1BD, United Kingdom.

It will be clear from the above that the land-based AC power system of FIG. 1 and the dedicated AC power system of FIG. 2 have certain technical disadvantages. Accordingly, there is a need for an alternative AC power system that is easy to implement and where the passage of harmonics from one AC voltage level to another AC voltage level can be reduced or eliminated.

### SUMMARY OF THE INVENTION

Accordingly, the present invention provides a multi-transformer unit for converting an input AC voltage at a first voltage level to a net output AC voltage at a second voltage level, the input voltage being polluted with at least one harmonic, the unit having primary and secondary sides and comprising at least two phase-shifting transformers, each transformer being operative to provide a phase shift relative to the first voltage level, wherein on the primary side of the unit the transformers are arranged for independent connection to the higher voltage level and on the secondary side of the unit the transformers are linked such that voltage vectors on the secondary side of the unit are added together to at least partially cancel the harmonic pollution and give the net output AC voltage.

The phase-shifts of the transformers are preferably selected to add into the net output AC voltage a significant voltage at the fundamental frequency of the input AC voltage.

Hence, the multi-transformer unit may comprise a first phase-shifting transformer for providing a first AC output voltage having a phase shift relative to the input AC voltage; and a second phase-shifting transformer for providing a second AC output voltage having a phase shift relative to the input AC voltage, the net output AC voltage being the vector sum of the first AC output voltage and the second AC output voltage; wherein the phase shift of the first AC output voltage and the phase shift of the second AC output voltage are selected to completely or partially cancel in the net AC output voltage of the multi-transformer unit one or more harmonics applied to the input AC voltage. The phase shift of the first AC output voltage and the phase shift of the second AC output voltage may be selected to completely or substantially add in the net AC output voltage of the multi-transformer unit the fundamental voltage/frequency applied to the input AC voltage of the multi-transformer unit.

It is envisaged that the phase shifts of at least a first and second of the phase-shifting transformers will differ from each other. The vector summing of the phase-shifting transformer outputs in the net output AC voltage can be achieved by connecting secondary windings of the transformers in series with each other.

Conventional phase-shifting transformers provide a well-defined phase shift at the fundamental frequency between the input (or primary) AC voltage and the output (or secondary) AC voltage. By combining two phase-shifting transformers together, the present invention may produce an overall phase shift at the fundamental frequency in the net output AC voltage of the multi-transformer unit compared to the input AC voltage.

The most important design factor is that the individual phase shifts provided by the phase-shifting transformers are selected to minimise the transfer of selected harmonics between the input AC voltage and the net output AC voltage of the multi-transformer unit. Another important design factor is that the individual phase shifts provided by the phase-shifting transformers are selected to give a significant voltage at the fundamental frequency in the net output AC voltage of the multi-transformer unit.

A suitable known type of phase-shifting transformer that can be used to implement the multi-transformer unit of the present invention is a phase-shifting transformer with star primary windings and with 15 degree phase shifted delta zigzag secondary windings, as supplied by Trasfor Electric Ltd of Sutton Coldfield, B74 4AA, United Kingdom.

Three or more phase-shifting transformers can also be used in a multi-transformer unit of the invention to minimise the transfer of a wider range of harmonics between the input AC voltage and the net AC output voltage of the multi-transformer unit, while still giving a significant voltage at the fundamental frequency in the net output AC voltage of the multi-transformer unit.

The multi-transformer unit of the present invention has several technical advantages: —
The multi-transformer unit uses two or more standard phase-shifting transformers whose properties are clearly defined and can be easily changed.
The multi-transformer unit will significantly reduce the magnitude of selected harmonics and in addition will not significantly increase the magnitude of any harmonics applied to the input AC voltage after the transformation ratio has been taken into account.
The multi-transformer unit removes the requirement for expensive rotary conversion or harmonic filters and can be used for a range of different input AC voltages with different fundamental frequencies. Moreover, the fundamental frequency of the net output AC voltage of the multi-transformer unit is the same as that of the input AC voltage.
The multi-transformer unit is cheaper, smaller and more reliable than the other solutions to the same technical problem.

There are several different circuits that are used by proven phase-shifting transformers to give a well-defined phase shift between the input AC voltage and the output AC voltage. In each case, the phase-shifting transformer has a set of primary windings and a set of secondary windings. In some cases the phase-shifting transformer can also have a set of tertiary windings. Examples of possible phase-shifting transformer circuits include a “star/extended star” circuit, a “star/delta” circuit, and a “star/extended delta” circuit. These are described in more detail below. Other circuits make use of dual primary windings or different interconnection patterns to give a well-defined phase shift between the input AC voltage and the output AC voltage. In general, it will be readily appreciated that the phase-shifting transformers in the unit can have any suitable circuit. Moreover, it will also be readily appreciated that it is not necessary for the phase-shifting transformers to have the same circuit types.

In the following description, any phase shift is at the fundamental frequency of the input AC voltage. If phase shifts are described at a harmonic frequency then these are clearly defined.

In a “star/extended star” circuit the primary windings are connected together in a conventional star configuration and the secondary windings are connected together in a conventional extended star configuration with extra windings on each limb of the core of the phase-shifting transformer. By varying the size and the number of turns of the extra windings it is possible to obtain a phase shift from 0 to more than 30 degrees. It is therefore possible for a first phase-shifting transformer using a “star/extended star” circuit to provide a first phase shift, and for a second phase-shifting transformer using a “star/extended star” circuit having extra windings with a different number of turns to provide a second phase shift.

In a “star/delta” circuit the primary windings are connected together in a conventional star configuration and the secondary windings are connected together in a conventional delta configuration. Alternatively, the primary windings may be connected together in a conventional delta configuration and the secondary windings may be connected together in a conventional star configuration. Similarly, in a “star/extended delta” circuit the primary windings are connected together in a conventional star configuration and the secondary windings are connected in a conventional extended delta configuration, with extra windings on each limb of the core of the phase-shifting transformer. By varying the size and the number of turns of the secondary winding it is possible to obtain a phase shift from 0 to more than 30 degrees. It is therefore possible for a first phase-shifting transformer using a “star/extended delta” circuit to provide a first phase shift, and for a second phase-shifting transformer using a “star/extended delta” circuit having extra windings with a different number of turns to provide a second phase shift.

In a preferred embodiment of the multi-transformer unit of the present invention, the primary windings of first and second phase-shifting transformers are connected in a conventional extended delta configuration and the secondary windings of each phase are connected together in series in a conventional star configuration to give a net output AC voltage that is the vector sum of the output AC voltages of the first and second phase-shifting transformers, the number of turns of each of the extended windings being selected to produce a selected overall phase shift in the net output AC voltage compared to the input AC voltage.

The phase-shifting transformers can be constructed as separate units or combined together in a single unit such that they share a common magnetic (steel) core.

If the input AC voltage and the output AC voltages of first and second phase-shifting transformers are considered as vectors then the angle between the input AC voltage and the output AC voltage from the first phase-shifting transformer can be represented as a first phase shift angle, and the angle between the input AC voltage and the output AC voltage from the second phase-shifting transformer can be represented as a second phase shift angle. If the first and second phase shift angles are different then the angle between them can be represented as a Difference Angle.

Selected harmonics can be almost completely cancelled by the multi-transformer unit by selecting a Difference Angle equal to 180 degrees/N. Hence, the Difference Angle should be selected to take any value that is chosen to produce the minimum transfer of harmonics from the input AC voltage to the net output AC voltage for any given AC power system.

It is important to note that the multi-transformer unit will still give the required net output AC voltage at the fundamental frequency of the input AC voltage by the correct choice of the number of turns in the transformer windings and allowing for the effect of the Difference Angle at the fundamental frequency.

The input AC voltage can be any value and can be higher or lower than the net output AC voltage of the multi-transformer unit by altering the design and/or configuration of the phase-shifting transformers.

The multi-transformer unit of the present invention can be used in place of a conventional transformer or an AC machine as part of a land-based or dedicated AC power system, for example. Any selected harmonic or harmonics applied to the AC higher voltage level can be partially or completely cancelled by the multi-transformer unit so that the distorting effects of the high power loads on the AC lower voltage level can be minimised.

The present invention also provides a method of converting an input AC voltage at a first voltage level to a net output AC voltage at a second voltage level by means of a multi-transformer unit, the input AC voltage being polluted with at least one harmonic, the unit having primary and secondary sides and comprising at least two phase-shifting transformers, the method comprising the steps of pre-selecting a phase shift relative to the first voltage level for each phase-shifting transformer, operating each phase-shifting transformer to provide the pre-selected phase shift on its secondary side, and adding voltage vectors from each phase-shifting transformer on the secondary side of the unit to at least partially cancel the harmonic pollution and give the net output AC voltage.

The step of pre-selecting the phase shifts of the phase-shifting transformers may include the step of selecting the phase-shifts to add into the net output AC voltage a significant voltage at the fundamental frequency of the input AC voltage.

In accordance with the above method, complete or partial cancellation of one or more harmonics in an input AC voltage is achieved by the steps of supplying the input AC voltage to a multi-transformer unit having a first phase-shifting transformer for providing a first AC output voltage with a phase shift relative to the input AC voltage and a second phase-shifting transformer for providing a second AC output voltage with a phase shift relative to the input AC voltage; performing the vector sum of the first output AC voltage and the second output AC voltage to determine the net output AC voltage of the multi-transformer unit at the fundamental and harmonic frequencies; selecting the phase shift of the first AC output voltage and the phase shift of the second AC output voltage to completely or partially cancel in the net AC output voltage of the multi-transformer unit the one or more harmonics in the input AC voltage. The step of selecting the phase shifts of the first and second AC output voltages may include the step of selecting the phase shifts to completely or substantially add in the net AC output voltage of the multi-transformer unit the fundamental voltage/frequency applied to the input AC voltage of the multi-transformer unit.

The step of selecting the phase shift of the first AC output voltage and the phase shift of the second AC output voltage to completely or partially cancel in the net AC output voltage of the multi-transformer unit the one or more harmonics in the input AC voltage may include the steps of: determining a Difference Angle according to the formula: Difference Angle=180 degrees/N, where N is a given harmonic of the fundamental frequency of the input AC voltage; and selecting the phase shift of the first AC output voltage and the phase shift of the second AC output voltage such that the angle between them is substantially equal to the Difference Angle.

### BRIEF DESCRIPTION OF THE DRAWINGS

Exemplary embodiments of the invention will now be described, with reference to the accompanying drawings, in which:

FIG. 1 is a schematic diagram showing a known land-based AC power system where the power conversion is carried out solely by AC transformers;

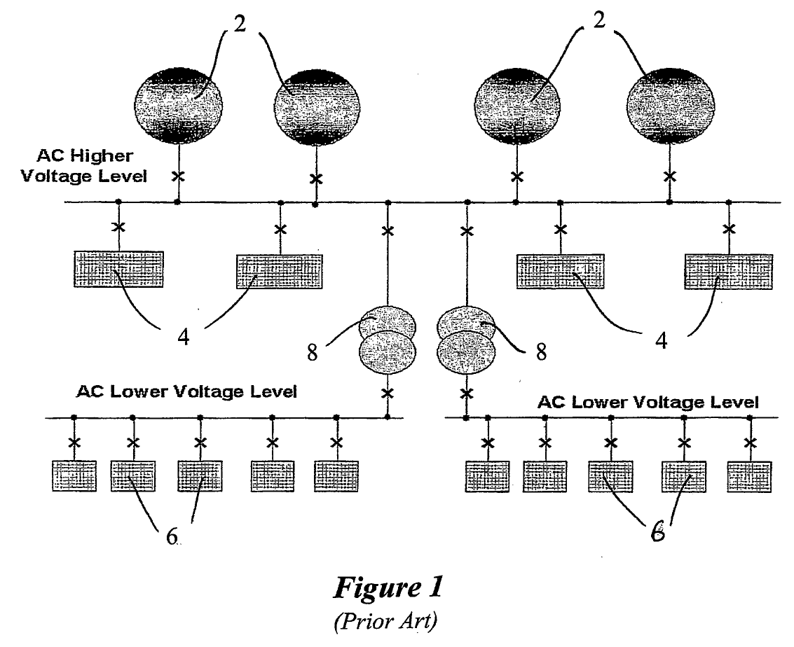

FIG. 2 is a schematic diagram showing a known dedicated AC power system where the power conversion is carried out using AC transformers and AC machines;

FIG. 3 is a schematic diagram showing first and second phase-shifting transformers having a “star/extended star” circuit, as known per se;

FIG. 4 is a schematic diagram showing first and second phase-shifting transformers having a “star/extended delta” circuit, as known per se;

FIG. 5 is a schematic diagram showing first and second phase-shifting transformers for use according to the present invention, having a “extended delta/star” circuit;

FIGS. 6A and 6B are schematic diagrams showing how the input AC voltage and the output AC voltages from first and second phase-shifting transformers, as used in the present invention, can be represented as vectors;

FIG. 7 is a schematic diagram showing a dedicated AC power system where the AC machines are replaced by an anti-harmonic transformer according to the present invention; and

FIG. 8 is a schematic diagram showing the design of the anti-harmonic transformer according to the present invention in more detail.

### DETAILED DESCRIPTION OF THE PREFERRED EMBODIMENTS

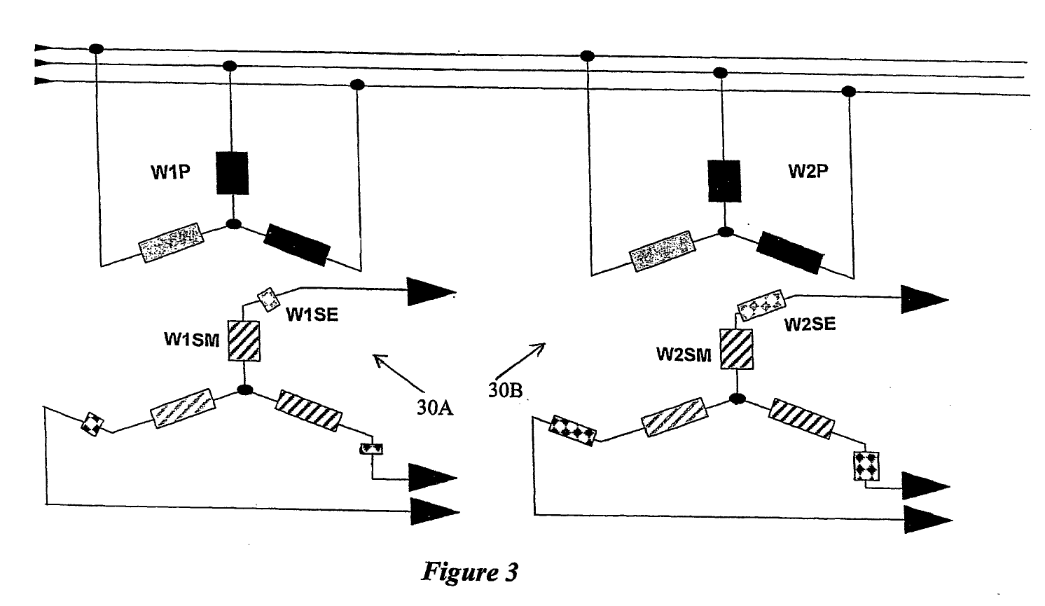

The types of phase-shifting transformer that can be used in an anti-harmonic multi-transformer unit of the present invention will first be described with reference to FIGS. 3 to 6 of the drawings.

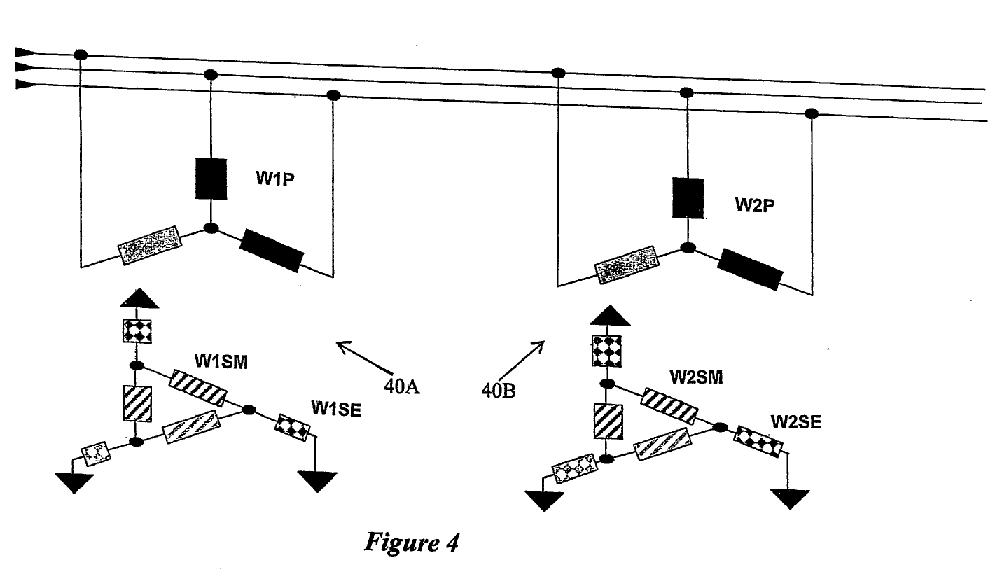

FIGS. 3 and 4 schematically show phase-shifting transformer of known types that are useable in the present invention.

In FIG. 3, a first phase-shifting transformer 30A uses a “star/extended star” circuit to provide a first phase shift, and a second phase-shifting transformer 30B uses a “star/extended star” circuit having extra windings with a different number of turns to provide a second phase shift. Transformer 30A has a 3-phase construction where three primary windings W1P are connected together in a conventional star configuration. Each of the three secondary windings includes a main winding W1SM and an extended winding W1SE, the secondary windings again being connected together in a conventional extended star configuration. The second phase-shifting transformer 30B is also of 3-phase construction, the three primary windings W2P being connected together in a conventional star configuration and the three secondary windings W2SM and W2SE being connected together in a conventional extended star configuration. In each case, the primary windings W1P and W2P are connected to the common 3-phase input AC voltage lines. It is arranged that the extended windings W2SE of the second phase-shifting transformer have more turns than the extended windings W1SE of the first phase-shifting transformer. Hence, the output AC voltage from the first phase-shifting transformer has a first phase shift relative to the common input AC voltage and the output AC voltage from the second phase-shifting transformer has a second phase shift relative to the common input AC voltage.

FIG. 4 schematically shows a first phase-shifting transformer 40A of 3-phase construction where the three primary windings W1P are connected together in a conventional star configuration. Each of the three secondary windings includes a main winding W1SM and an extended winding W1SE that are connected together in a conventional extended delta configuration. A second phase-shifting transformer 40B of 3-phase construction has three primary windings W2P connected together in a conventional star configuration and three secondary windings W2SM and W2SE connected together in a conventional extended delta configuration. In each case, the primary windings W1P and W2P are connected to the common 3-phase input AC voltage. The extended windings W2SE of the second phase-shifting transformer have more turns than the extended windings W1SE of the first phase-shifting transformer. Hence, the output AC voltage from the first phase-shifting transformer has a first phase shift relative to the common input AC voltage and the output AC voltage from the second phase-shifting transformer has a second phase shift relative to the common input AC voltage.

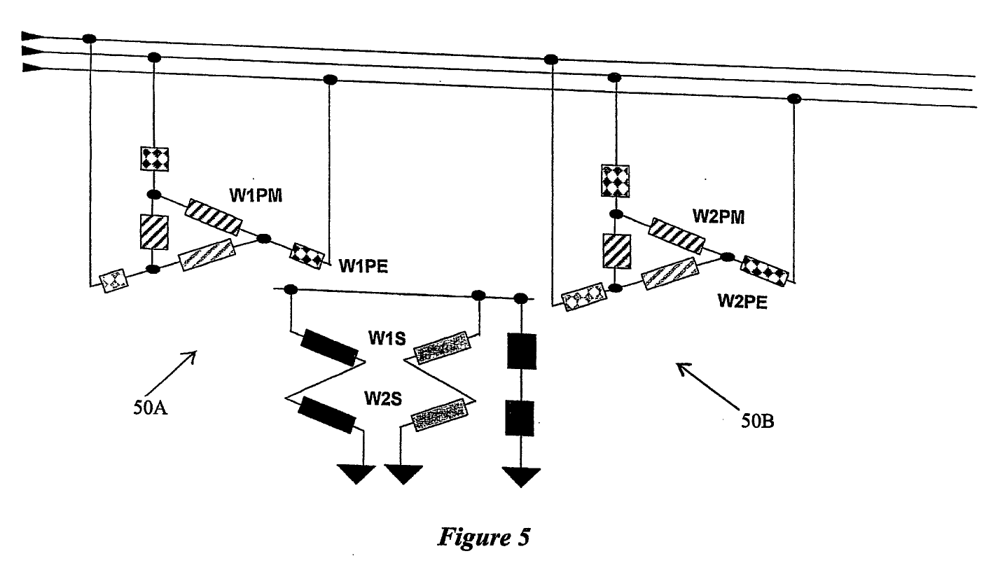

FIG. 5 schematically shows an embodiment of the invention, in which a first phase-shifting transformer 50A is of 3-phase construction, each of the three primary windings being connected in a conventional extended delta configuration, with a main winding W1PM and an extended winding WIPE. A second phase-shifting transformer 50B is of similar construction, each of the three primary windings including a main winding W2PM and an extended winding W2PE. The primary windings of both transformers 50A and 50B are connected to the common 3-phase input AC voltage lines. However, in accordance with the invention, the secondary windings W1S and W2S of the first and second phase-shifting transformers 50A, 50B, respectively, are connected together in series in a conventional star configuration to give a net output AC voltage that is the vector sum of the output AC voltages of the first and second phase-shifting transformers. The extended primary windings W2PE of the second phase-shifting transformer 50B have more turns than the extended primary windings WIPE of the first phase-shifting transformer 50A. Hence, the output AC voltage in the secondary windings W1S of the first phase-shifting transformer 50A has a first phase shift relative to the common input AC voltage and the output AC voltage from in the secondary windings W2S of the second phase-shifting transformer 50B has a second phase shift relative to the common input AC voltage. The number of turns of each of the extended windings W1PE and W2PE can be selected to produce a selected overall phase shift in the net output AC voltage compared to the input AC voltage.

NOTE: in FIG. 5, the third phase secondary windings W1S, W2S of the first and second phase-shifting transformers 50A, 50B, are diagrammatically shown in a “straight” series connection, though in fact they would be in a star formation with the other two phases.

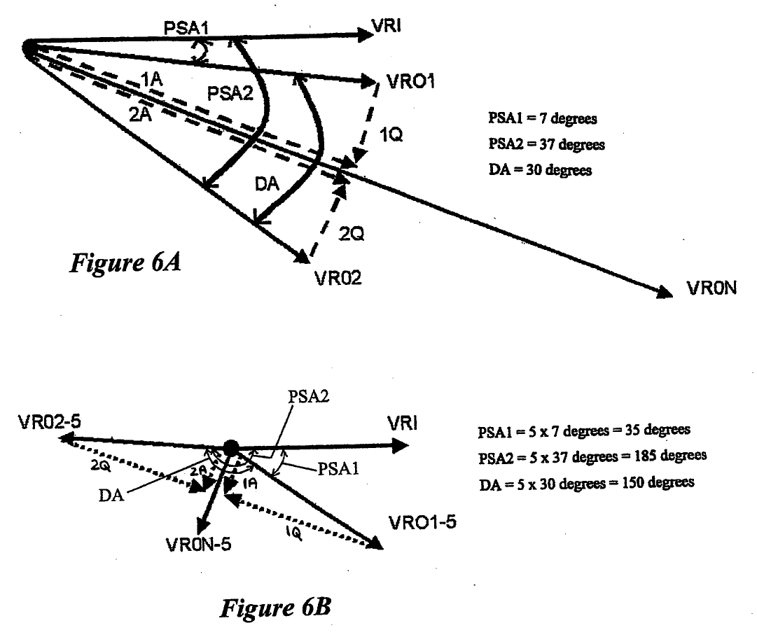

The complete or partial cancellation of the one or more harmonics in the net AC output voltage of the multi-transformer unit and the substantial adding of the fundamental voltage/frequency in the net output voltage are explained below with reference to FIGS. 6A and 6B.

FIG. 6A schematically shows the input and output AC voltages of first and second phase-shifting transformers as voltage vectors at the fundamental frequency where VRI is the voltage vector for the common input AC voltage, VRO1 is the voltage vector for the output AC voltage from the first phase-shifting transformer and VRO2 is the voltage vector for the output AC voltage from the second phase-shifting transformer. Accordingly, PSA1 is the phase shift angle between VRO1 and VRI, PSA2 is the phase shift angle between VRO2 and VRI and DA is the Difference Angle between VRO1 and VRO2.

As a typical example, FIG. 6A shows PSA1 equal to 7 degrees and PSA2 equal to 37 degrees. This gives a Difference Angle DA of 30 degrees. The voltage vector VRO1 can be represented by two component vectors at 90 degrees to each other shown as 1A and 1Q. In the same way, the voltage vector VRO2 can be represented by two component vectors 2A and 2Q. The two small voltage vectors 1Q and 2Q cancel each other. However, the two large voltage vectors 1A and 2A add to give a significant value for the net output vector VRON.

If the input AC voltage has a fundamental frequency F then the frequency of a given harmonic at N times the fundamental frequency is F×N. Moreover, for a fundamental phase shift angle Z, the phase shift angle at the frequency of the given harmonic N is N×Z. In other words, if the fundamental frequency is 50 Hz (a common network or grid frequency) and the fundamental phase shift angle is 30 degrees then the frequency of the fifth harmonic is 50 Hz×5=250 Hz and the phase shift angle at this frequency is 5×30 degrees=180 degrees. Using this principle, selected harmonics can be almost completely cancelled by the multi-transformer unit by selecting a Difference Angle equal to 180 degrees/N. Therefore, for the example given above, the Difference Angle should be selected to be 180 degrees/5=36 degrees. Similarly, for the seventh harmonic then the Difference Angle should be selected to be 180 degrees/7=25.7 degrees. If a mixture of fifth and seventh harmonics are applied to the input AC voltage then the Difference Angle can be selected to a value like 30 degrees so that both of the harmonics are partially cancelled.

With reference to FIG. 6B, VRI is again the common input AC voltage vector. At the fifth harmonic the phase shift PSA1 of the voltage vector VRO1 for the output AC voltage from the first phase-shifting transformer is shown as VRO1-5 and is equal to 5×7 degrees=35 degrees. Similarly, the phase shift PSA2 of the voltage vector VRO2 for the output AC voltage from the second phase-shifting transformer is shown as VRO2-5 and is equal to 5×37 degrees=185 degrees. The Difference Angle DA at the fifth harmonic is therefore 150 degrees. The vector components of VRO1-5 and VRO2-5 are shown and vectors 1A and 2A virtually cancel. Vectors 1Q and 2Q add to give a net output vector VRON-5, which is a small voltage compared to either VRO1-5 or VRO2-5. If the Difference Angle at the fundamental frequency had been set to 36 degrees the Difference Angle at the fifth harmonic would have been 5×36 degrees=180 degrees, and VRO1-5 and VRO2-5 would cancel exactly.

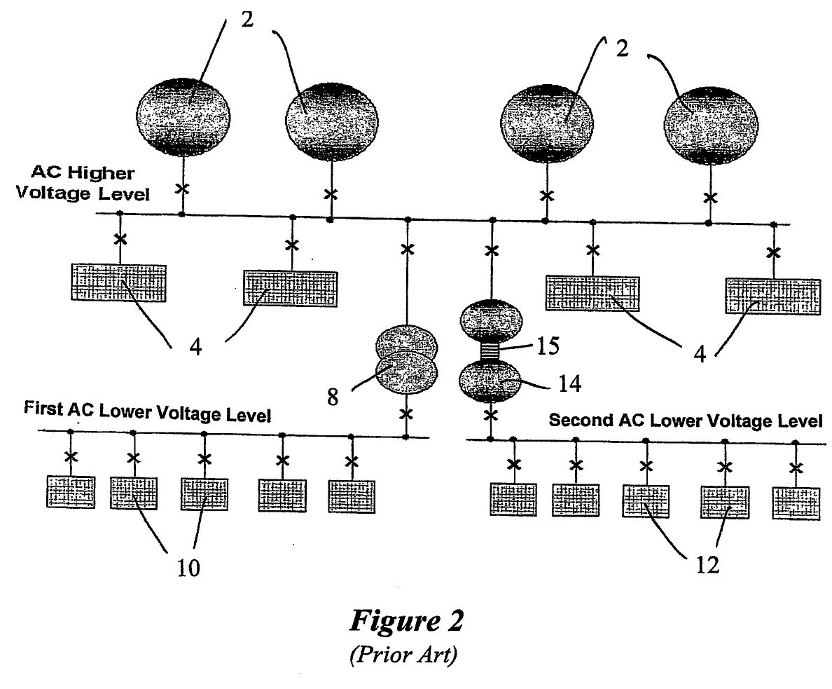

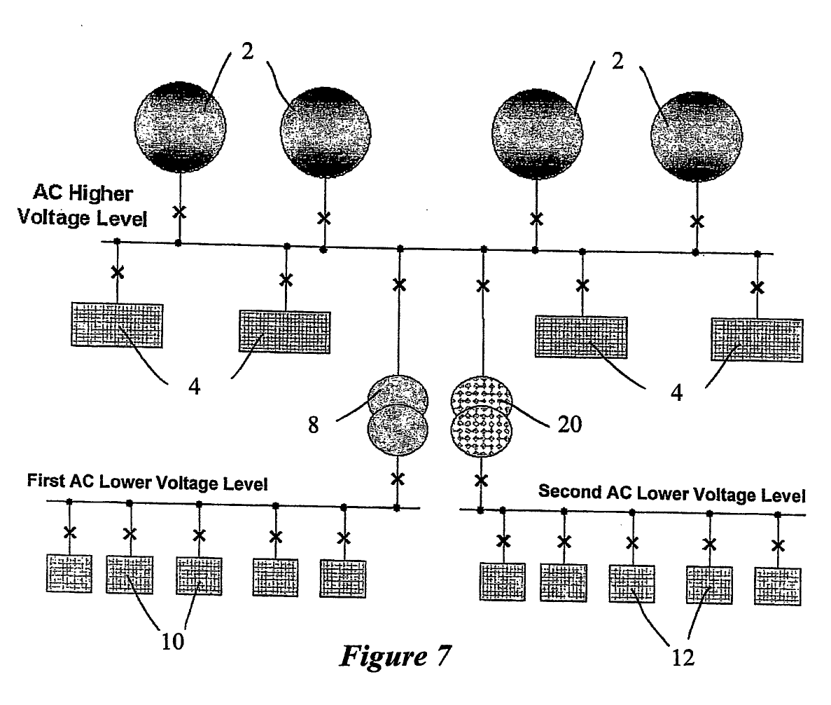

FIG. 7 shows a dedicated AC power system that is similar to that shown in FIG. 2 and like components have been given the same reference numerals. The only difference is that the AC machines 14 have been replaced by an anti-harmonic transformer unit 20 according to the present invention.

A number of AC power generators 2 generate power at an AC higher voltage level of, say, 11 kV (3-phase). The power is supplied directly to a series of high power loads 4 such as high power thyristor converters feeding motors used in steel mills. An AC transformer 8 is used to convert the power from the AC higher voltage to a first AC lower voltage level of 240 V (3-phase) where it is supplied to a series of insensitive low power loads 10 such as a AC motors driving compressors. An anti-harmonic transformer unit 20 is used to convert the power from the AC higher voltage level to the second AC lower voltage level of 240 V (3-phase) where it is supplied to a series of sensitive low power loads 12 such as computers and televisions.

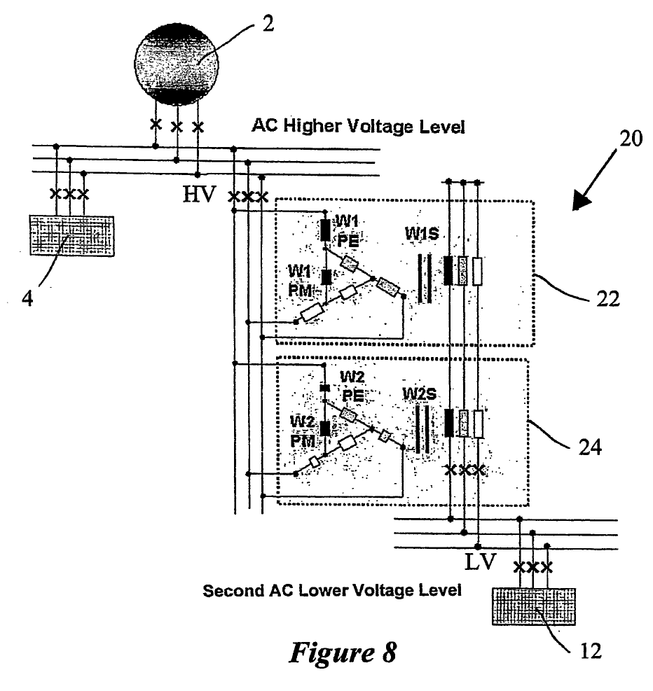

With reference to FIG. 8, the anti-harmonic transformer unit 20 includes a first phase-shifting transformer 22 and a second phase-shifting transformer 24. Both of the phase-shifting transformers 22 and 24 use a conventional 3-phase construction with a steel magnetic core (not shown). The primary windings of the first and second phase-shifting transformers 22 and 24 are arranged in an extended delta configuration as described above.

The primary windings of the first phase-shifting transformer 22 are connected to the AC higher voltage level HV and include main windings W1PM and extended windings WIPE. Similarly, the primary windings of the second phase-shifting transformer 24 are connected to the AC higher voltage level HV and include main windings W2PM and extended windings W2PE. The secondary windings W1S and W2S of the first and second phase-shifting transformers 22 and 24 are connected together in series in a conventional star configuration as described above in relation to FIG. 5, though for drafting convenience they are diagrammatically shown in a “straight” series connection to each other.

The output AC voltage in the secondary windings W1S of the first phase-shifting transformer 22 will have a well-defined phase shift compared to the AC higher level voltage HV. Similarly, the output AC voltage in the secondary windings W2S of the second phase-shifting transformer 24 will have a well-defined phase shift compared to the AC higher level voltage HV. The net output AC voltage LV of the anti-harmonic transformer unit 20 is the vector sum of the output AC voltages in the secondary windings W1S and W2S of the first and second phase-shifting transformers 22 and 24. By altering the ratio of the number of turns on the extended windings WIPE and W2PE of the first and second phase-shifting transformers 22 and 24, an overall predefined phase shift can be produced in the net output AC voltage LV of the anti-harmonic transformer unit 20 compared to the AC higher level voltage HV. The predefined phase shift of the first and second phase-shifting transformers 22 and 24 can be set to a particular value such that any harmonics present in the AC higher level voltage are completely or partially cancelled.

For example, when the output AC voltages in the secondary windings W1S and W2S are considered as vectors, a set of angles such as those shown in FIGS. 6A and 6B can be selected. A different set of angles can be selected to minimise a defined set of harmonics. The anti-harmonic transformer unit 20 can therefore be used to prevent any harmonics present in the AC higher voltage level HV from being transferred to the AC lower voltage level, or at least attenuate them.

1-15. (canceled)

16: A multi-transformer unit (20) for converting an input AC voltage at a first voltage level to a net output AC voltage at a second voltage level, the input voltage being polluted with at least one harmonic, the unit having primary and secondary sides and comprising at least two phase-shifting transformers, each transformer being operative to provide a phase shift relative to the first voltage level, wherein on the primary side of the unit the transformers are arranged for independent connection to the first voltage level and on the secondary side of the unit the transformers are linked such that voltage vectors on the secondary side of the unit are added together to at least partially cancel the harmonic pollution and give the net output AC voltage.

17: The multi-transformer unit according to claim 16, in which the phase-shifts of the transformers are selected to add into the net output AC voltage a significant voltage at the fundamental frequency of the input AC voltage.

18: The multi-transformer unit according to claim 16, in which the phase shifts of at least a first and second of the phase-shifting transformers are different.

19: The multi-transformer unit according to claim 16, in which at least first and second phase-shifting transformers have primary and secondary windings and the secondary windings of at least the first and second phase-shifting transformers are connected together in series to give the net output AC voltage.

20: The multi-transformer unit according to claim 19, in which at least one of the primary and secondary windings of at least one of the phase-shifting transformers includes a set of main windings and a set of extended windings.

21: The multi-transformer unit according to claim 20, in which a set of extended windings of a first phase-shifting transformer and a set of extended windings of a second phase-shifting transformer have a different number of turns such that the phase shifts they contribute to the net output AC voltage of the unit are different.

22: The multi-transformer unit according to claim 19, in which connections of the primary and secondary windings of the phase-shifting transformers are selected from the group consisting of:
the primary windings connected together in a star configuration and the secondary windings connected together in an extended star configuration;
the primary windings connected together in an extended star configuration and the secondary windings connected together in a star configuration;
the primary windings connected together in an extended star configuration and the secondary windings connected together in a extended star configuration;
the primary windings connected together in a delta configuration and the secondary windings connected together in a star configuration;
the primary windings connected together in a delta configuration and the secondary windings connected together in an extended star configuration;
the primary windings connected together in an extended delta configuration and the secondary windings connected together in a star configuration; and
the primary windings connected together in an extended delta configuration and the secondary windings connected together in an extended star configuration.

23: The multi-transformer unit according to claim 19, in which at least one of the phase-shifting transformers also includes a set of tertiary windings.

24: The multi-transformer unit according to claim 16, consisting of two phase-shifting transformers.

25: The multi-transformer unit according to claim 16, in which the phase-shifting transformers have a common magnetic core.

26: The multi-transformer unit according to claim 16, arranged to give a net output AC voltage of lower value than the input AC voltage.

27: The multi-transformer unit according to claim 16, arranged to give a net output AC voltage at least equal in value to the input AC voltage.

28: A method of converting an input AC voltage at a first voltage level to a net output AC voltage at a second voltage level by means of a multi-transformer unit, the input voltage being polluted with at least one harmonic, the unit having primary and secondary sides and comprising at least two phase-shifting transformers, the method comprising the steps of pre-selecting a phase shift relative to the first voltage level for each phase-shifting transformer, operating each phase-shifting transformer to provide the pre-selected phase shift on its secondary side, and adding voltage vectors from each phase-shifting transformer on the secondary side of the unit to at least partially cancel the harmonic pollution and give the net output AC voltage.

29: The method according to claim 28, in which the step of pre-selecting the phase shifts of the phase-shifting transformers includes the step of selecting the phase-shifts to add into the net output AC voltage a significant voltage at the fundamental frequency of the input AC voltage.

30: The method according to claim 28, in which the step of pre-selecting the phase shifts of the phase-shifting transformers includes the steps of:
determining a Difference Angle according to the formula, Difference Angle=180 degrees/N, where N is a given harmonic of the fundamental frequency of the input AC voltage; and
selecting the phase shifts of the first and second phase-shifting transformers such that the angle between them is substantially equal to the Difference Angle.
